(19) United States
(12) Patent Application Publication
(10) Pub. No.: US 2015/0253873 A1
(43) Pub. Date: Sep. 10, 2015

(54) ELECTRONIC DEVICE, METHOD, AND COMPUTER READABLE MEDIUM

(71) Applicant: NIKON CORPORATION, Tokyo (JP)

(72) Inventors: Takuya SATO, Tokyo (JP); Daiki ITO, Tokyo (JP); Satoshi EJIMA, Tokyo (JP); Minako NAKAHATA, Kamakura-shi (JP); Hiroyuki MUSHU, Tokyo (JP); Tomoko SUGAWARA, Yokohama-shi (JP); Masakazu SEKIGUCHI, Kawasaki-shi (JP)

(73) Assignee: NIKON CORPORATION, Tokyo (JP)

(21) Appl. No.: 14/616,084

(22) Filed: Feb. 6, 2015

Related U.S. Application Data
(63) Continuation of application No. PCT/JP2013/003092, filed on May 15, 2013.

(30) Foreign Application Priority Data
Aug. 6, 2012 (JP) 2012-173879
Aug. 6, 2012 (JP) 2012-173880

(51) Int. Cl. G06F 3/03; G06F 3/01

(52) U.S. Cl. CPC G06F 3/0304; G06F 3/017

(57) ABSTRACT

In order to provide an easy-to-use apparatus, provided is an electronic device comprising an input section that inputs information relating to a first instrument in a hand of a user; a control section that controls display in a display section based on the information input by the input section; an image capturing section that is capable of capturing an image of the user and the first instrument; an image adjusting section that adjusts the image captured by the image capturing section, according to the first instrument in the hand of the user; and a determining section that determines what body part of the user the first instrument is to be used on, based on the information relating to the first instrument. The image adjusting section adjusts at least one of a display region and size of the image captured by the image capturing section.

### CROSS REFERENCE TO RELATED APPLICATION

The contents of the following Japanese patent applications and PCT patent application are incorporated herein by reference:

No. JP2012-173879 filed on Aug. 6, 2012,

No. JP2012-173880 tiled on Aug. 6, 2012, and

No. PCT/JP2013/003092 filed on May 15, 2013.

### BACKGROUND

1. Technical Field

The present invention relates to an electronic device, method, and computer readable medium.

2. Related Art

A conventional orientation viewing apparatus has been proposed for checking the orientation of a user from behind.

Patent Document 1: Japanese Patent Application Publication No. 2010-87569

However, the conventional orientation viewing apparatus is considered difficult to operate, and is therefore not an easily used device.

### SUMMARY

Therefore, it is an object of an aspect of the innovations herein to provide an electronic device, method, and computer readable medium, which are capable of overcoming the above drawbacks accompanying the related art. The above and other objects can be achieved by combinations described in the claims. According to a first aspect of the present invention, provided is an electronic device comprising an input section that inputs information relating to a first instrument in a hand of a user and a control section that controls display in a display section based on the information input by the input section. Also provided is a method and computer readable medium

According to a second aspect of the present invention, provided is an electronic device comprising an input section that inputs information relating to a first instrument in a hand of a user and a predicting section that predicts movement of the user based on the information input by the input section.

The summary clause does not necessarily describe all necessary features of the embodiments of the present invention. The present invention may also be a sub-combination of the features described above.

### BRIEF DESCRIPTION OF THE DRAWINGS

FIG. 1 is a block diagram showing a display system 1 according to the present embodiment.

FIG. 2 shows an overview of the display system.

FIG. 3 shows the process flow of the control section 19 of the display apparatus 10 according to the present embodiment.

FIG. 4A shows a state in which the user is holding the portable device 20 in the vertical position and facing toward the display apparatus 10.

FIG. 4B shows a state in which the user is holding the portable device 20 in a vertical position and facing away from the display apparatus 10.

FIG. 5A shows a state in which the user faces away from the display apparatus 10, and then once again faces toward the display apparatus 10.

FIG. 5B shows a state in which the user holds the portable device 20 in the horizontal position and faces toward the display apparatus 10.

FIG. 6A shows a state in which the user faces sideways relative to the display apparatus 10.

FIG. 6B shows a state in which the user faces diagonally forward relative to the display apparatus 10.

FIG. 7 shows a block diagram of the display system 1 according to a modification of the present embodiment.

FIG. 8 shows an overview of the display system 1 according to the present modification.

FIG. 9 shows an exemplary external view of a makeup tool 50.

FIG. 10 shows the process flow of the control section 19 of the display apparatus 10 according to the present modification.

FIG. 11A shows an example in which an image of the entire face of the user and an image of the mouth of the user are displayed separately.

FIG. 11B shows an example in which an image of the entire face of the user and an image of both eyes of the user are displayed separately.

FIG. 12A shows a state in which the user applies the makeup to the right eye.

FIG. 12B shows a state in which the user applies the makeup to the left eye.

FIG. 13 shows an example in which an image of the entire face of the user and an image of the right eye of the user are displayed separately.

FIG. 14A shows a state in which one enlarged image is displayed.

FIG. 14B shows a state in which a plurality of enlarged images over time are shown.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

### Configuration of the Display System

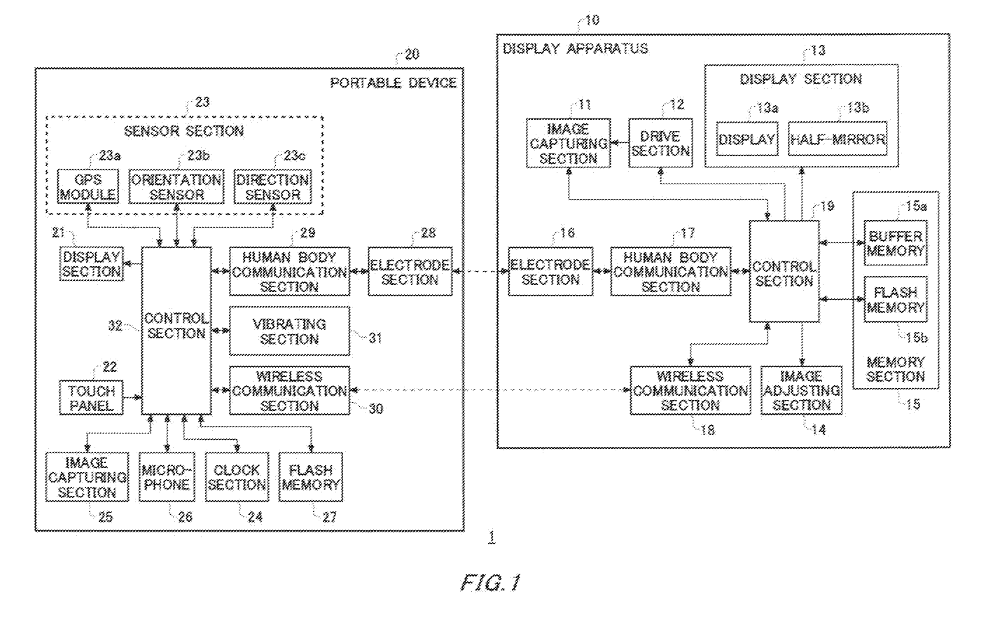

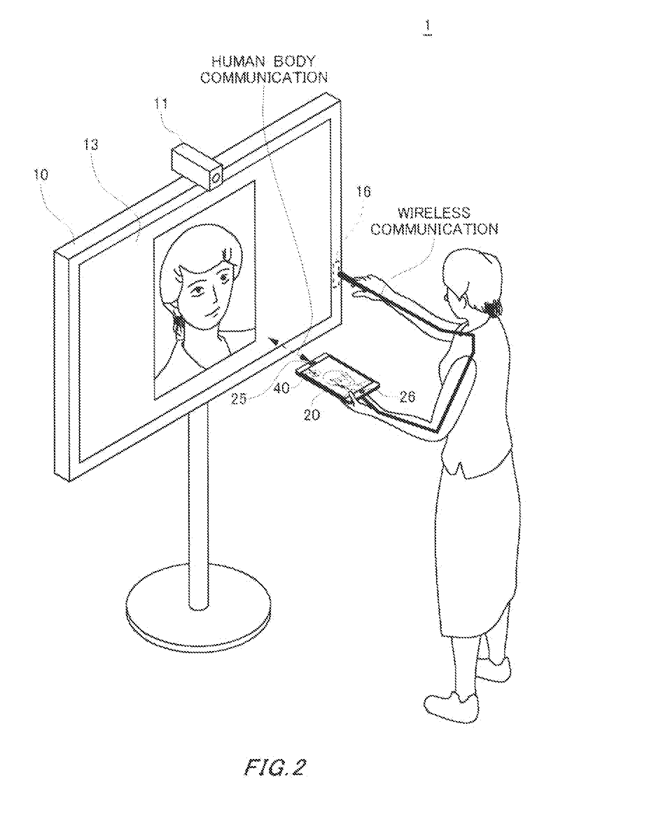

FIG. 1 is a block diagram showing a display system 1 according so the present embodiment. FIG. 2 shows an overview of the display system 1. The following description references FIGS. 1 and 2. The display system 1 is used as an orientation viewing apparatus by which a user checks their own orientation, for example.

The display system 1 views the orientation of the user by using a display apparatus 10 and a portable device 20 that is held by the user. The display apparatus 10 and the portable device 20 can send and receive data through human body communication and wireless communication.

The display apparatus 10 and the portable device 20 usually function as apparatuses that are independent from each other, but instead operate in conjunction when paired (a process by which the apparatuses recognize each other) through human body communication.

Human body communication refers to communication that uses a person, which is a conductor, as a communication medium, and includes methods such as an electric current method that involves transmitting information by running a very small current through the human body and modulating the current and an electrical field method that involves transmitting information by modulating the electric field induced on the surface of the human body. In the present embodiment, it is possible to use both the electric current method and the electric field method, but the following describes an example in which the electric field method is used. Furthermore, instead of the human body communication method, the display apparatus 10 and the portable device 20 may be paired with non-contact communication such as FeliCa (Registered Trademark), close proximity wireless transfer technology such as TransferJet (Registered Trademark), or close proximity communication such as near-field communication (NFC).

### The Display Apparatus 10

The display apparatus 10 is a device that includes a display region with a diagonal length greater than 20 inches, for example. The display apparatus 10 includes an image capturing section 11, a drive section 12, a display section 13, an image adjusting section 14, a memory section 15, an electrode section 16, a human body communication section 17, a wireless communication section 18, and a control section 19.

The image capturing section 11 includes a lens group and an image capturing element, such as a CCD (Charged Coupled Device) image sensor or a CMOS (Complementary Metal Oxide Semiconductor) sensor. The image capturing section 11 is provided on an upper portion of the display apparatus 10, for example, and captures an image of the face (or entire body) of the user positioned in front of the display apparatus 10 to output a moving image or still image. The image capturing section 11 may include a zoom lens as a portion of the lens group.

The drive section 12 drives the image capturing section 11 in a tilting direction, i.e. pivoting in a vertical direction, and a panning direction, i.e. pivoting in a horizontal direction, thereby changing the image capturing direction of the image capturing section 11. The drive section 12 can use a DC motor, a voice coil motor, or a linear motor, for example.

The display section 13 includes a display 13a, e.g. a liquid crystal display apparatus, that displays the image captured by the image capturing section 11 on a display surface and a half-mirror 13b that is provided overlapping the display surface of the display 13a. The half-mirror 13b is formed by depositing a metal film on a transparent substrate made of glass or the like or by affixing a translucent film to a transparent board, for example. The half-mirror 13b reflects light incident to one side thereof, and passes light incident to the side opposite this one side thereof. By including this half-mirror 13b, the display section 13 enables the user positioned in front of the display apparatus 10 to view both the image captured by the image capturing section 11 and the reflected mirror image of the user. Furthermore, the display section 13 displays an indication that human body communication is established and an indication that wireless communication is established, thereby informing the user of the communication state.

The display section 13 may display the image captured by the image capturing section 11 without including the half-mirror 13b. As another example, the display region of the display section 13 may be divided to form a region in which the mirror image from the half-mirror 13b and the image captured by the image capturing section 11 can both be seen and a region in which only one of the mirror image and the captured image can be seen.

The image adjusting section 14 adjusts the image captured by the image capturing section 11, and displays the resulting image in the display section 13. Specifically, the image adjusting section 14 trims a portion of the image captured by the image capturing section 11, enlarges the trimmed image, shifts the trimming position of the image, and displays the resulting image in the display section 13.

The memory section 15 includes a buffer memory 15a and a nonvolatile flash memory 15b. The buffer memory 15a temporarily stores the image data captured by the image capturing section 11, and is used as a work memory of the image adjusting section 14. The buffer memory 15a may be a volatile semiconductor memory, for example. Image data that is designated by the user from among the image data stored in the buffer memory 15a is transferred to the flash memory 15b, which stores the transferred image data. The flash memory 15b stores various types of data, such as the program data to be executed by the control section 19.

The electrode section 16 includes a signal electrode and a ground electrode, and exchanges signals with the portable device 20 through the user with human body communication. The electrode section 16 is provided on the front surface of the display apparatus 10, to be easily reached by a hand of the user. With the electric field method of human body communication, communication is obviously possible when the user is bare-handed, i.e. when the hand of the user is in contact with the electrode section 16, but communication is also possible even when the user is wearing gloves, i.e. when the hand of the user is opposite the electrode section 16. Therefore, the electrode section 16 may be provided within a casing formed of plastic, resin, or the like. Furthermore, the ground electrode may be connected to the ground of the circuit board of the display apparatus 10.

The human body communication section 17 is connected to the electrode section 16, includes a transceiver section that is formed from an electrical circuit having a band-pass filter, generates reception data by demodulating a reception signal input thereto, and generates a transmission signal by modulating data to be transmitted. The human body communication section 17 transmits and receives information to and from the portable device 20 through the body of the user with human body communication. For example, the human body communication section 17 receives an ID of the portable device 20 and transmits an ID of the display apparatus 10 to the portable device 20. Furthermore, the human body communication section 17 transmits, to the portable device 20, a switching signal for switching to other communication methods.

The wireless communication section 18 transmits and receives the information to and from the portable device 20 using wireless communication such as wireless LAN (Local Area Network), BlueTooth (Registered Trademark), or infrared communication. As an example, the wireless communication section 18 transmits, to the portable device 20, image data stored in the buffer memory 15a.

The control section 19 includes a CPU (Central Processing Unit) and is connected to the image capturing section 11, the drive section 12, the display 13a of the display section 13, the image adjusting section 14, the memory section 15 (including the buffer memory 15a and the flash memory 15b), the human body communication section 17, and the wireless communication section 18, and performs overall control of the display apparatus 10. for example, the control section 19 controls the processes for communicating with the portable device 20.

### The Portable Device 20

The portable device 20 is a device such as a mobile telephone, a smart phone, or a tablet computer. The portable device 20 includes a display section 21, a touch panel 22, a sensor section 23, a clock section 24, an image capturing section 25, a microphone 26, a flash memory 27, an electrode section 28, a human body communication section 29, a wireless communication section 30, a vibrating section 31, and a control section 32.

The display section 21 is a liquid crystal display or an organic EL display, for example, and is controlled by the control section 32 to display data such as image data or character data and to display operational buttons and menus that are manipulated by the user. The display section 21 may also display an indication that human body communication is established and an indication that wireless communication is established, by displaying an icon, for example. In this case, the communication state may be displayed when it is determined that the user is bedding the portable device 20, based on the output of the electrode section 28 described further below, or that the user can see the display section 21, based on the output of the orientation sensor 23b described further below. The display region of the display section 13 of the display apparatus 10 has a diagonal length of tens of inches while the display region of the display section 21 has a diagonal length of several inches, such that the display section 21 is smaller than the display section 13 of the display apparatus 10.

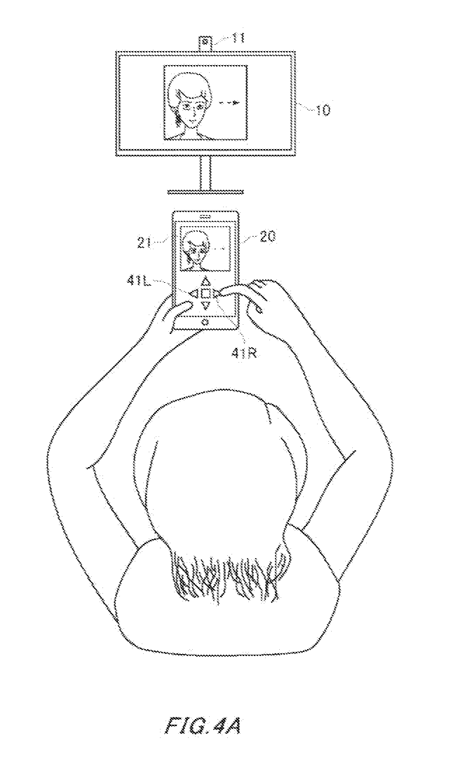

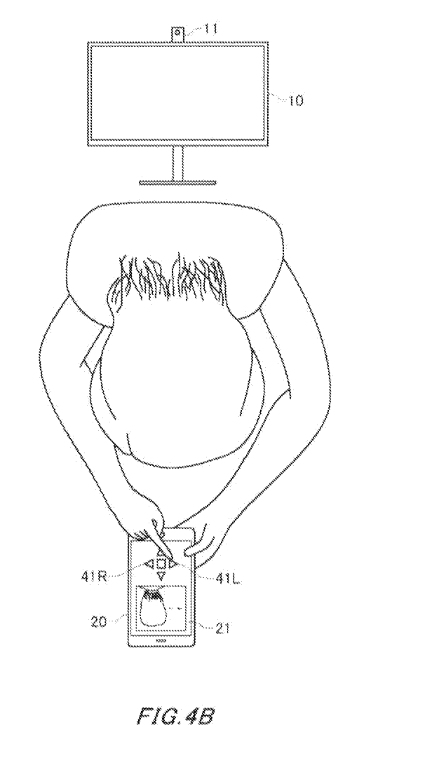

The touch panel 22 is formed integrally with the display section 21, and is a manipulation section that receives manipulation input when the user manipulates menus or virtual manipulation buttons, e.g. the right manipulation mark 41R or the left manipulation mark 41L shown in FIGS. 4A and 4B, that are displayed in the display section 21. The touch panel 22 may use technology such as a resistance film technique, a surface acoustic wave technique, an infrared technique, an electromagnetic induction technique, or an electrostatic capacitance technique. Manipulation buttons may be used instead of or in addition to the touch panel 22.

The sensor section 23 includes a GPS (Global Positioning System) module 23a, an orientation sensor 23b, and a direction sensor 23c. In addition to these components, the sensor section 23 may include a biometric sensor for acquiring biometric information of the user.

The GPS module 23a detects the position (longitude and latitude) of the portable device 20. The position information (information concerning the position where the user is present) detected by the GPS module 23a is written to the flash memory 27 by the control section 32.

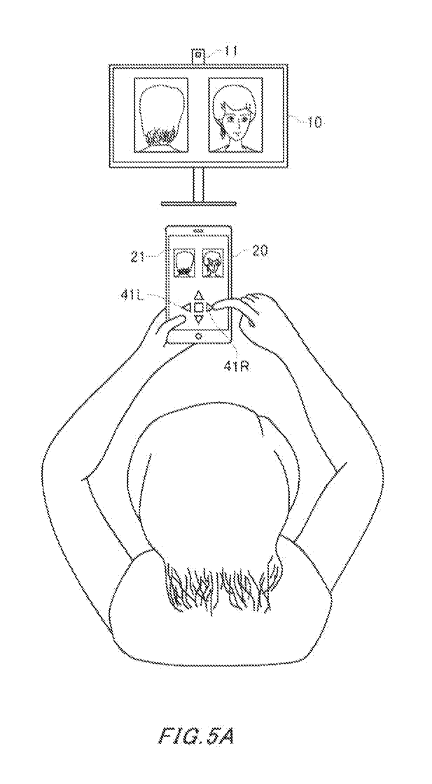

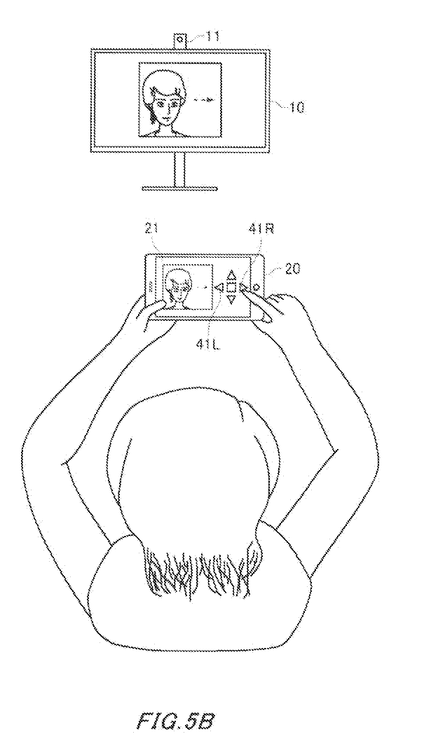

The orientation sensor 23b is a sensor that detects the orientation of the portable device 20 and, in the present embodiment, detects the angle at which the user is holding the portable device 20 and whether the user is holding the portable device 20 in a vertical position or horizontal position. Here, a vertical position refers to a state in which the user is holding the display section 21 of the portable device 20 as shown in FIG. 2, and a horizontal position refers to a state in which the user is holding the display section 21 of the portable device 20 rotated 90 degrees from the horizontal position, as shown in FIG. 5B described further below.

The orientation sensor 23b is formed by a combination of sensors that detect the orientation in the direction of one axis by detecting whether infrared light of a photo-interrupter is blocked by a small sphere that moves according to gravity. Instead of this, the orientation sensor 23b may be formed using a three-axis acceleration sensor or a gyro sensor. Furthermore, the orientation sensor 23b may have a configuration to detect whether the portable device 20 is in the vertical position or horizontal position based on the position of the fingers of the user touching the touch panel 22.

The orientation sensor 23b may have a configuration to detect whether the portable device 20 is in the vertical position or horizontal position based on the position of the fingers of the user touching electrodes provided on almost all of the side surfaces of the casing. In this case, the capacitance value and resistance value of the electrodes touched by the fingers are decreased, and therefore the orientation sensor 23b detects the change in the capacitance value or resistance value of the electrodes to detect electrodes being touched by the hand. Furthermore, when such an orientation sensor 23b is provided, the portable device 20 may have the electrodes with decreased resistance or capacitance values function as the electrode section 28 used for the human body communication.

The orientation information of the portable device 20 detected by the orientation sensor 23b is used for adjusting the orientation of the image displayed in the display section 21, for example.

The direction sensor 23c is a sensor for detecting the direction, and detects the direction based on a magnetic field detection value obtained with a two-axis magnetic sensor that detects geomagnetic components in directions orthogonal to each other. In the present embodiment, the direction detected by the direction sensor 23c is used to determine the direction of the user relative to the display apparatus 10, e.g. whether the user is facing toward the display apparatus 10 or facing away from the display apparatus 10.

In the present embodiment, the direction detected by the direction sensor 23c is displayed as direction information 40 in the portable device 20, as shown in FIG. 2, for example.

The clock section 24 detects the current time, and measures the passage of time during a designated period. The clock section 24 outputs the detection results and the time measurement results to the control section 32.

The image capturing section 25 includes a lens group and an image capturing element such as a CCD image sensor or CMOS sensor, captures an image of a subject, and outputs a moving image, still image, or the like. In the present embodiment, the image capturing section 25 is provided above the display section 21 on the same surface, and can capture an image of the user using the portable device 20.

The microphone 26 is provided below the display section 21 on the same surface, and mainly acquires sound created by the user. The flash memory 27 is a nonvolatile memory, and stores various types of data transmitted from the display apparatus 10, detection data of the sensor section 23, application programs of the portable device 20, and the like.

The electrode section 28 includes a signal electrode and a ground electrode, and exchanges signals with the display apparatus 10 through the user with human body communication. The electrode section 28 is provided on the side surface or back surface of the portable device 20, for example, to be easily touched by the user. With the electric field method of human body communication, the electrode section 28 may be provided within a casing formed of plastic, resin, or the like. Furthermore, the ground electrode may be connected to the ground of the circuit board of the portable device 20.

The human body communication section 29 is connected to the electrode section 28, includes a transceiver section that is formed from an electrical circuit having a band-pass filter, generates reception data by demodulating a reception signal input thereto, and generates a transmission signal by modulating data to be transmitted. The human body communication section 29 transmits an ID of the portable device 20 to the display apparatus 10 and receives an ID of the display apparatus 10. Furthermore, the human body communication section 29 receives, from the display apparatus 10, a switching signal for switching to other communication methods.

The wireless communication section 30 transmits and receives the information to and from the display apparatus 10 using wireless communication such as wireless LAN (Local Area Network), BlueTooth (Registered Trademark), or infrared communication. As an example, the wireless communication section 30 receives image data from the display apparatus 10, and transmits, to the display apparatus 10, the orientation detected by the orientation sensor 23b and the position detected by the direction sensor 23c.

The vibrating section 31 includes a vibrating motor, and causes the portable device 20 to vibrate according to a plurality of vibration patterns. In the present embodiment, the vibrating section 31 vibrates for a few seconds when communication using the human body communication section 29 or communication using the wireless communication section 30 is established, and also vibrates for a few seconds when this established communication ends. Furthermore, the vibrating section 31 can have various settings for the type of communication, periods of vibration for distinguishing when communication is established (started) and when communication ends, strength of the vibration, and the like.

The control section 32 includes a CPU, is connected to the display section 21, the touch panel 22, the sensor section 23, the clock section 24, the image capturing section 25, the microphone 26, the flash memory 27, the human body communication section 29, and the vibrating section 31, and performs overall control of the portable device 20. For example, the control section 32 changes the orientation of the image displayed in the display section 21 according to the output of the orientation sensor 23b and controls the communication with the display apparatus 10. Furthermore, the control section 32 may execute various functions such as communication functions or wallet functions.

There are cases where the wireless communication section 30 of the portable device 20 and the wireless communication section 18 of the display apparatus 10 have difficulty communicating. In such a case, in the display system 1, a plurality of receiving sections may be provided separately from the display apparatus 10 in the space where the display apparatus 10 is arranged, and the direction of the user may be detected based on the receiving section having the strongest communication strength from among the plurality of receiving sections.

### Process Flow of the Display System 1

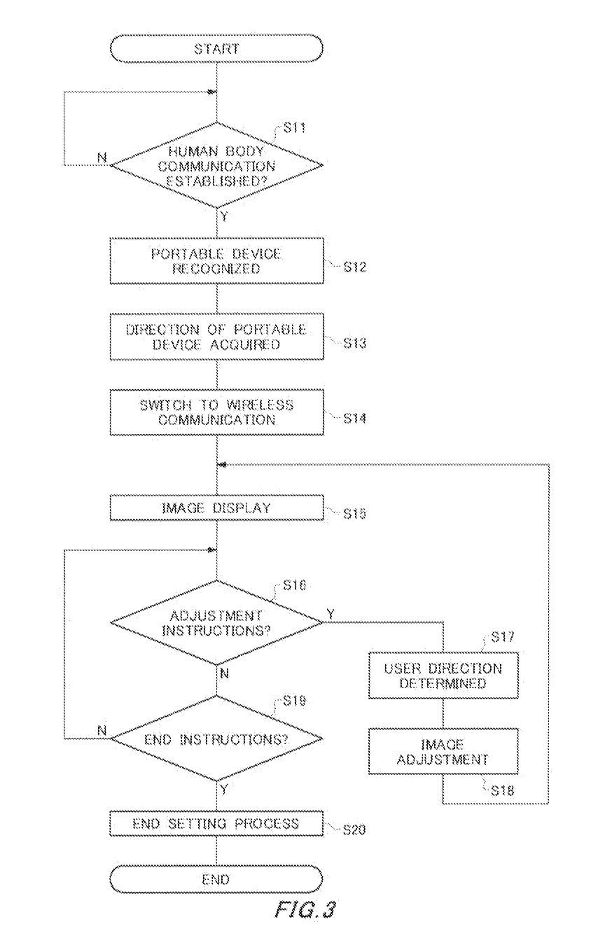

FIG. 3 shows the process flow of the control section 19 of the display apparatus 10 according to the present embodiment. When the display apparatus 10 and the portable device 20 are operating together, while the user is holding the portable device 20 in a prescribed orientation (the vertical position or horizontal position) with one hand, the user touches the electrode section 16 of the display apparatus 10 with the other hand while in a state facing in a prescribed direction relative to the display apparatus 10, e.g. facing toward the display apparatus 10. In response to this action, the present flow chart is begun. As long as the user holds the portable device 20 with a prescribed orientation at a location enabling human body communication, the portable device 20 does not need to be held in the hand and may be in the pocket instead, for example.

First, at step S11, in response to the user touching the electrode section 16, the control section 19 of the display apparatus 10 determines whether human body communication is established with the portable device 20, and waits to perform processing until the human body communication is established. The control section 19 proceeds to step S12 when the human body communication is established. The control section 19 displays an indication that human body communication has been established in the display section 13.

Next, at step S12, the control section 19 transmits to the portable device 20 an ID transmission request, using the human body communication. Upon receiving the ID transmission request from the display apparatus 10, the control section 32 of the portable device 20 transmits the ID of the portable device 20 and the user information to the display apparatus 10, using the human body communication. Prior to this transmission, the control section 32 may ask the user whether it is acceptable to transmit the ID and the user information to the display apparatus 10. The control section 19 receives the ID of the portable device 20 and the user information via the human body communication, and recognizes the portable device 20. In order to notify the user that human body communication has been established, the control section 32 performs at least one of displaying an indication in the display section 21 and causing a vibration with the vibrating section 31. By providing notification indicating that human body communication has been established on the portable device 20 side in this way, even if the user unintentionally establishes the human body communication, e.g. when the portable device 20 is grabbed suddenly, the user can understand that human body communication has been established.

The control section 19 may acquire the recognition of the portable device 20 and a usage history of the display apparatus 10 by the user of the recognized portable device 20, from the flash memory 15b. By performing this process of step S12, the control section 19 can complete the pairing between the portable device 20 and the display apparatus 10 using human body communication.

Next, at step S13, the control section 19 acquires the direction of the portable device 20 using the human body communication. As a result, the control section 10 can recognize the direction, e.g. Northwest, detected by the direction sensor 23c of the portable device 20 in a state where the user is touching the electrode section 16 of the display apparatus 10, e.g. a state in which the user is facing toward the display apparatus 10.

As long as the direction of the user when the user touches the electrode section 16 of the display apparatus 10 is a predetermined direction, the user need not be facing toward the display apparatus 10 and may be facing another direction, e.g. a horizontal direction. The control section 19 may perform steps S12 and S13 in the opposite order, or may perform steps S12 and S13 as a single step.

Next, at step S14, the control section 19 transmits the switching signal for the communication method to the portable device 20, using the human body communication, and the communication method between the display apparatus 10 and the portable device 20 is switched from human body communication to wireless communication. As a result, the control section 19 can transmit and receive data to and from the portable device 20 while the hand of the user is separated from the display apparatus 10. Furthermore, since wireless communication has a higher data transfer rate than human body communication, the control section 19 can transmit and receive large amounts of data, such as images, to and from the portable device 20. After the paring described above has been established, the control section 10 switches to wireless communication using the wireless communication sections 18 and 30 in response to the user removing their hand from the electrode section 16 of the display apparatus 10. In response to the switching of the communication method, an indication that wireless communication has been established is displayed in the display sections 13 and 21, and the vibration pattern of the vibrating section 31 is switched.

Next, at step S15, the control section 19 displays, in the display section 13, the image data obtained by the image capturing section 11 capturing an image of the user. Furthermore, the control section 19 transmits the image data of the user captured by the image capturing section 11 to the portable device 20, using wireless communication, and displays this image data in the display section 21 of the portable device 20.

In response to the user manipulating the touch panel 22 of the portable device 20, the control section 19 may display the image data in one of the display section 13 of the display apparatus 10 and the display section 21 of the portable device 20. When there is a predetermined angular change in the detection output of the direction sensor 23c, the control section 19 may receive notification from the portable device 20 indicating that the direction of the user has reversed. In this case, the control section 19 may stop the display in the display section 13 of the display apparatus 10 that cannot be seen by the user.

Nest, at step S16, the control section 19 determines whether adjustment instructions for the image have been received through wireless communication from the portable device 20. Specifically, the control section 19 determines whether adjustment instructions for shifting the display range of the image to the right or to the left have been received from the portable device 20. A detailed example of manipulation for the adjustment instructions is provided further below with reference to FIGS. 4 to 6.

When adjustment instructions are received from the portable device 20, the control section 19 proceeds to the process of step S17. At step S17, the control section 19 recognizes the direction of the portable device 20 and determines the current direction of the user relative to the display apparatus 10, e.g. whether the user is facing toward the display apparatus 10 or away horn the display apparatus 10, based on the recognized direction. A detailed example of the method for determining the direction of the user is described further below with reference to FIGS. 4 to 6, along with the description of the manipulation method for the adjustment instructions.

The control section 19 detects whether the face of the user is contained in the image captured by the image capturing section 11, and if the face can be detected, may determine that the user is facing toward the display apparatus 10. Furthermore, according to whether the face of the user is contained in the image captured by the image capturing section 11, the control section 19 may correct the determined direction of the user based on the direction of the portable device 20.

When the direction of the user relative to the display apparatus 10 is determined, next, at step S18, the control section 19 adjusts the display range of the image captured by the image capturing section 11. Specifically, the control section 19 shifts the display range of the image captured by the image capturing section 11 to the right or the left, according to the adjustment instructions of the user. When the image adjustment of step S18 is completed, the control section 19 returns to the process of step S15 and displays the image, which has undergone the image adjustment, in the display section 13 of the display apparatus 10 and the display section 21 of the portable device 20.

On the other hand, if it is determined at step S16 that there are no adjustment instructions, the control section 19 proceeds to the process of step S19. At step S19, the control section 19 determines whether end instructions have been received from the portable device 20.

For example, in the case where human body communication is established between the display apparatus 10 and the portable device 20 and pairing of the display apparatus 10 and portable device 20 is established, the control section 32 of the portable device 20 displays an icon indicating establishment of the pairing and a cancellation icon for cancelling the pairing, in the display section 21. When the pairing cancellation icon is manipulated by the user, the control section 32 of the portable device 20 transmits end instructions to the display apparatus 10, using wireless communication. When these end instructions are received from the portable device 20, the control section 19 of the display apparatus 10 determines that the user has given instructions to cancel the pairing. The communication distance of the wireless communication section 18 of the display apparatus 10 is set to be several meters, for example, and the pairing may be cancelled when the communication with the wireless communication section 30 of the portable device 20 exceeds a prescribed time, or the pairing time with the display apparatus 10 may be set to a billing amount.

When it is determined that end instructions are not received, the control section 19 returns to the process of step S16, and the processing remains in standby at steps S16 and S19 until adjustment instructions or end instructions are acquired. When end instructions are received, the control section 19 proceeds to the process of step S20.

At step S20, the control section 19 performs the end setting process. The control section 10 makes an inquiry to the user as to whether the image stored in the buffer memory 15a of the memory section 15 is to be saved in the flash memory 15b, for example, and in response to receiving save instructions from the user, transfers the image stored in the buffer memory 15a to the flash memory 15b to be stored therein. When making the inquiry to the user concerning whether to save the image, the control section 10 may display a thumbnail of the image stored in the buffer memory 15a in the display section 13 of the display apparatus 10 or the display section 21 of the portable device 20.

In a case where the display system 1 is used on a commercial basis, the control section 19 performs billing during the end setting process of step S20. When the process of step S20 is completed, the control section 19 exits the flow chart and ends the processing.

### Image Adjustment Method When Facing Toward the Display Apparatus

FIG. 4A shows a state in which the user is holding the portable device 20 in the vertical position and facing toward the display apparatus 10.

When the user faces toward the display apparatus 10, the display apparatus 10 and the portable device 20 display the image captured by the image capturing section 11, i.e. the image of the front of the user. Furthermore, the control section 32 of the portable device 20 displays, in the display section 21, a right manipulation mark 41R that is an arrow mark pointing to the right of the screen and a left manipulation mark 41L that is an arrow mark pointing to the left of the screen, and these marks receive the manipulation input.

In a state where the user faces toward the display apparatus 10, when the user wants to shift the display range of the images in the display apparatus 10 and the portable device 20 to the right, the user touches the right manipulation mark 41R. Furthermore, when the user wants to shift the display range of the images in the display apparatus 10 and the portable device 20 to the left, the user touches the left manipulation mark 41L.

When the right manipulation mark 41R or the left manipulation mark 41L is manipulated, the control section 32 of the portable device 20 transmits the type of button manipulated, the manipulation amount (e.g. the number of touches), and the current direction (e.g. Northwest) along with the image adjustment instructions to the display apparatus 10, using wireless communication. The control section 32 may receive the shift manipulation from mechanical buttons or keys, instead of from the manipulation input shown in the display section 21.

When the image adjustment instructions are received from the portable device 20, the control section 19 of the display apparatus 10 compares the direction at the time of the pairing to the current direction, and determines the current direction of the user relative to the display apparatus 10. More specifically, if the direction at the time of pairing (e.g. Northwest) is the same as the current direction (e.g. Northwest), then the control section 19 determines that the direction of the user is the same as at the time of pairing (e.g. the user is facing toward the display apparatus 10). This determination may be performed by the control section 32 of the portable device 20.

When the direction of the user is the same as at the time of pairing, the control section 19 of the display apparatus 10 shifts the display range of the images displayed in the display apparatus 10 and the portable device 20 by the manipulation amount (e.g. a distance corresponding to the number of touches) in the direction of the manipulated button. More specifically, in a state where the user is facing toward the display apparatus 10, the control section 19 shifts the display range to the right when the right manipulation mark 41R is touched and shifts the display range to the left when the left manipulation mark 41L is touched. In this way, the control section 19 can shift the display range of the image in accordance with the intent of the user.

### Image Adjustment Method When Facing Away From the Display Apparatus

FIG. 4B shows a state in which the user is holding the portable device 20 in a vertical position and facing away from the display apparatus 10.

When the user is facing away from the display apparatus 10, the portable device 20 displays the image captured by the image capturing section 11, i.e. an image of the back of the user. In this way, the user can recognize their own back by viewing the portable device 20.

When the detection output of the direction sensor 23c indicates that the direction of the user has changed by a prescribed angle from the direction at the time that the user was facing toward the display apparatus 10, the control section 32 of the portable device 20 may notify the display apparatus 10 that the direction of the user has reversed such that the user is facing away from the display apparatus 10. Furthermore, when this notification is received, the user cannot see the image, and therefore the control section 19 of the display apparatus 10 may stop displaying the image.

In a state where the user is facing away from the display apparatus 10, when the user wants to shift the display range for the image of the portable device 20 to the right, the user touches the right manipulation mark 41R. Furthermore, when the user wants to shift the display range for the image of the portable device 20 to the left, the user touches the left manipulation mark 41L.

When the right manipulation mark 41R or the left manipulation mark 41L is manipulated, the control section 32 of the portable device 20 transmits the type of button manipulated, the manipulation amount, and the current direction (e.g. Southeast) along with the image adjustment instructions to the display apparatus 10, using wireless communication.

When the image adjustment instructions are received from the portable device 20, the control section 19 of the display apparatus 10 compares the direction at the time of the pairing to the current direction, and determines the current direction of the user relative to the display apparatus 10. More specifically, if the direction at the time of pairing (e.g. Northwest) differs from the current direction (e.g. Southeast) by 180 degrees, then the control section 19 determines that the direction of the user is different from the direction at the time of pairing (e.g. the user is facing away from the display apparatus 10).

When the user is facing away from the display apparatus 10, the left and right directions of the image capturing section 11 of the display apparatus 10 are the reverse of the left and right directions of the manipulation buttons displayed in the portable device 20. Therefore, when the user is facing away from the display apparatus 10, the control section 19 of the display apparatus 10 shifts the display range of the image by the manipulation amount (e.g. a distance corresponding to the number of touches) in a direction that is opposite the direction of the manipulated button.

More specifically, in a state where the user is facing away from the display apparatus 10, the control section 19 of the display apparatus 10 shifts the display range to the left when the right manipulation mark 41R is touched and shifts the display range to the right when the left manipulation mark 41L is touched. In this way, even when the user is facing away from the display apparatus 10, the control section 19 can shift the display range of the image in the direction intended by the user.

### Display Method When the User Again Faces the Display Apparatus After Facing Away from the Display Apparatus

FIG. 5A shows a state in which the user faces away from the display apparatus 10, and then once again faces toward the display apparatus 10.

When the user is facing away from the display apparatus 10, the control section 19 of the display apparatus 10 records the image captured by the image capturing section 11, i.e. the image of the back of the user, in the buffer memory 15a. When the user faces away from the display apparatus 10 and then once again faces the display apparatus 10, the control section 19 displays the image of the back of the user stored in the buffer memory 15a alongside the image of the user facing the display apparatus 10, in a manner to not overlap. In a case where the display section 13 includes the half-mirror 13b, the control section 19 displays the image of the back of the user alongside the mirror image of the user reflected by the half-mirror 13b, in a manner to not overlap.

In this way, the control section 19 of the display apparatus 10 enables the user to recognize the image of their back and the image of their front at the same time, without requiting any special manipulation by the user. When a manipulation to end the display of the back image is received at the touch panel 22 of the portable device 20, e.g., when a manipulation of tapping the image is received on the touch panel 22, the control section 10 ends the display of the back image.

Even when the user is facing sideways relative to the display apparatus 10, the control section 19 of the display apparatus 10 may perform a similar process. In this way, the control section 19 of the display apparatus 10 can enable the user to see the front image and the sideways image of the user at the same time.

### Display Method When the Orientation of the Portable Device 20 Switches from the Vertical Position to the Horizontal Position

FIG. 5B shows a state in which the user holds the portable device 20 in the horizontal position and faces toward the display apparatus 10.

When the user switches the orientation of the portable device 20 from the vertical position so the horizontal position, the control section 32 of the display apparatus 10 rotates the direction of the image displayed in the display section 21 by 90 degrees according to the output of the orientation sensor 23b, such that the head of the user is positioned at the top. Furthermore, the control section 32 also rotates the display positions of the right manipulation mark 41R and the left manipulation mark 41L by 90 degrees, such that the user sees the right manipulation mark 41R displayed on the right side and sees the left manipulation mark 41L displayed on the left side.

When the orientation of the portable device 20 is switched from the vertical position to the horizontal position (or switched from the horizontal position to the vertical position), the direction of the user does not change, and therefore the control section 32 causes the output of the direction sensor 23c to remain the same as before the switching. For example, when changing from a state in which the portable device 20 is held in the vertical position and the output of the direction sensor 23c indicates North, for example, to a state in which the user holds the portable device 20 in the horizontal position, the control section 32 keeps the same output for the direction sensor 23c, such that the direction remains North after switching to the horizontal position. In this way, even when the orientation of the portable device 20 is switched, the same direction can be output.

### Display Methods in Other Cases

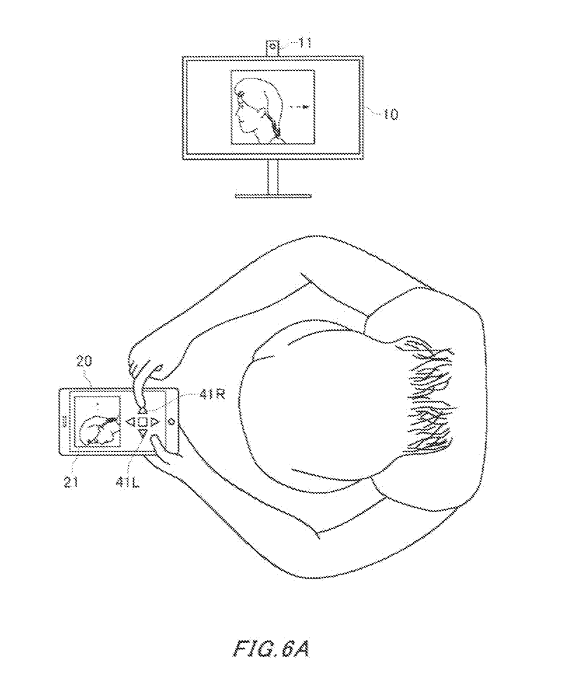

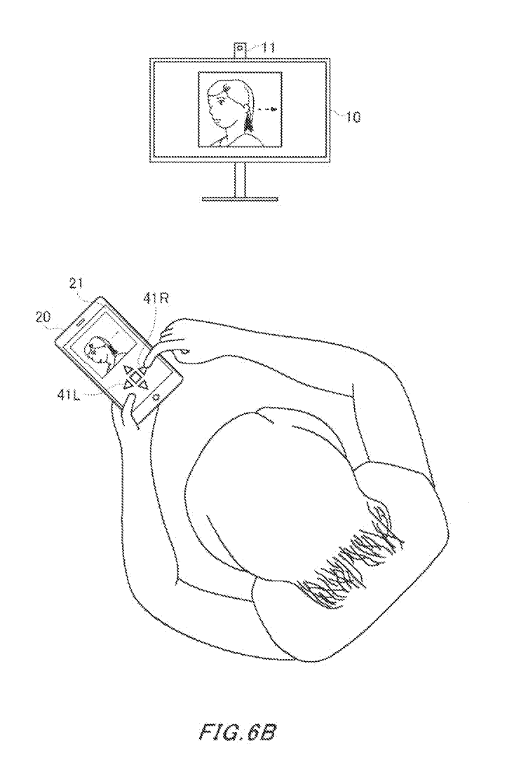

FIG. 6A shows a state in which the user faces sideways relative to the display apparatus 10. FIG. 6B shows a state in which the user faces diagonally forward relative to the display apparatus 10.

As shown in FIG. 6A, the user may face sideways relative to the display apparatus 10 (at a 90 degree angle relative to the display apparatus 10) and manipulate the portable device 20. As shown in FIG. 6B, the user may face diagonally forward relative to the display apparatus 10 and manipulate the portable device 20.

In these cases, the control section 19 of the display apparatus 10 shifts the images in the same manner as in the case where the user faces toward the display apparatus 10. In other words, when the right manipulation mark 41R is manipulated, the display apparatus 10 shifts the display range to the right, and when the left manipulation mark 41L is manipulated, the display apparatus 10 shifts the display range to the left.

Furthermore, the user may face diagonally away from the display apparatus 10 and manipulate the portable device 20. For example, in a case where the user is facing farther back than 90 degrees (or 270 degrees) relative to the display apparatus 10 and manipulates the portable device 20, the display apparatus 10 shifts the image in the same manner as in a case where the user is facing away from the display apparatus 10. In other words, when the right manipulation mark 41R is manipulated, the display apparatus 10 shifts the display range to the left, and when the left manipulation mark 41L is manipulated, the display apparatus 10 shifts the display range to the right.

The portable device 20 may also shift the display range in response to a manipulation of sliding the image with one or two fingers, for example.

In this case, in a state where the user is facing toward the display apparatus 10, the display apparatus 10 shifts the display range to the right when the image is slid to the right and shifts the display range to the left when the image is slid to the left. Furthermore, in a state where the user is facing away from the display apparatus 10, the display apparatus 10 shifts the display range to the left when the image is slid to the right and shifts the display range to the right when the image is slid to the left.

The control section 19 of the display apparatus 10 may display gesture menus for performing various manipulations through gestures, in the display section 13 of the display apparatus 10. In this case, the control section 19 detects the position of a hand of the user using an infrared apparatus, for example, and may detect which gesture menu the user has selected.

### Configuration of the Display System 1 According to a Modification

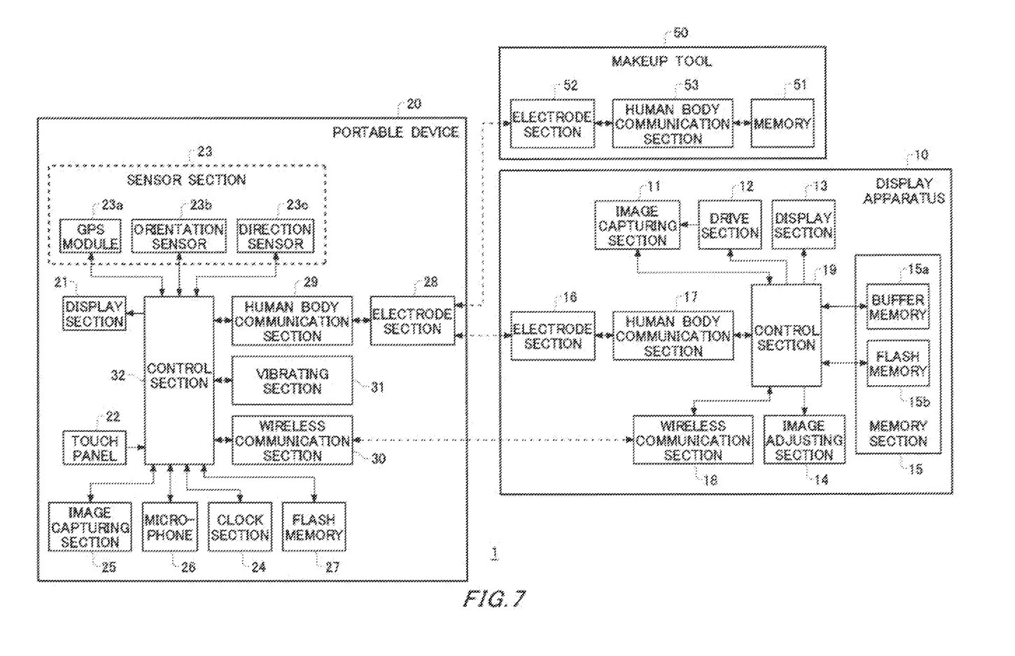

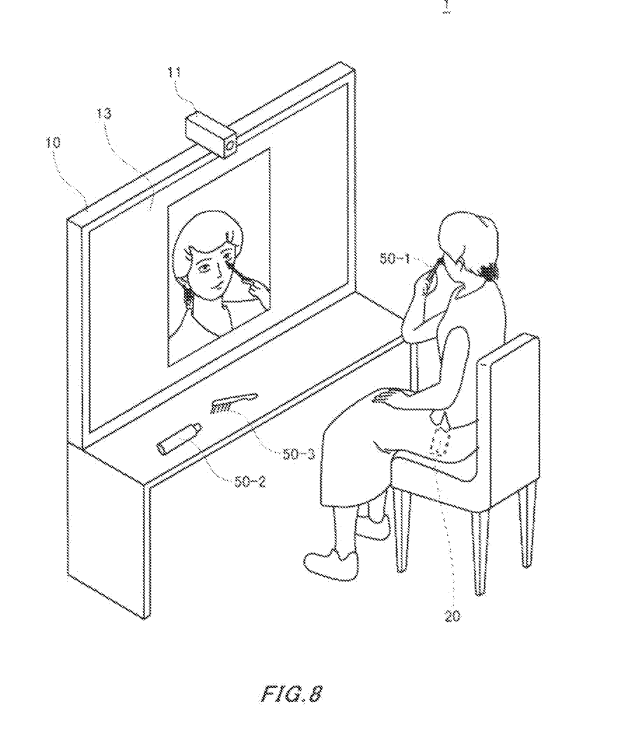

FIG. 7 shows a block diagram of the display system 1 according to a modification of the present embodiment. FIG. 8 shows an overview of the display system 1 according to the present modification. The following description references FIGS. 7 and 8. The display system 1 according to the present modification has substantially the same function and configuration as the display system 1 according to the embodiment described in FIGS. 1 to 6, and therefore components having substantially the same function and configuration are given the same reference numerals, and redundant descriptions are omitted.

The display system 1 according to the present modification further includes at least one makeup tool 50. As shown in FIG. 8, the makeup tools 50 (50-1, 50-2, and 50-3) are tools such as makeup or eyeliner for applying makeup to the face of the user or tools such as a comb or contact lens case used on the body, and have a function to transmit information to the portable device 20 through human body communication.

Furthermore, in the present modification, the display section 13 of the display apparatus 10 does not include the half-mirror 13b. In the present modification, as long as the portable device 20 can reliably establish at least human body communication, the portable device 20 need not be held in the hand of the user and can be inserted into a pocket, for example.

Each makeup tool 50 includes a memory 51, an electrode section 52, and a human body communication section 53, and realizes a function of transmitting and receiving information to and from the portable device 20 through human body communication.

The memory 51 may he a nonvolatile memory, and stores data for identifying the makeup tool 50. The memory 51 also stores information relating to a part of the body (e.g. eyes, mouth, eyelashes, eyebrows, or cheeks) on which the makeup tool 50 is to be used and information indicating whether the body part is positioned on the left or right side of the body.

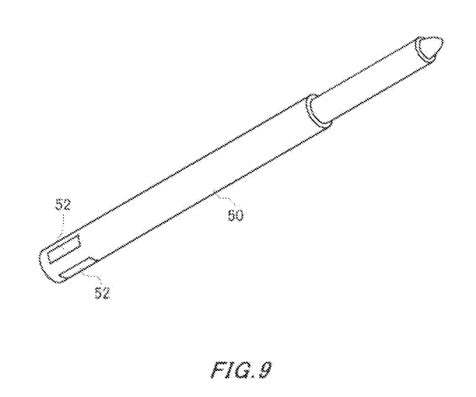

The electrode section 52 includes a signal electrode and a ground electrode, and transmits and receives signals to and from the portable device 20 through the user with human body communication. As shown in FIG. 9, for example, a plurality of the electrode sections 52 are provided at positions that can be easily touched by the hand when the user holds the makeup tool with their hand. When using the electric field method of human body communication, the electrode sections 52 may be provided inside casings formed of plastic, resin, or the like. Furthermore, the arrangement of the electrode sections 52 is not limited to the positions shown in FIG. 9, and the electrode sections 52 may be arranged anywhere that can be easily touched by the user.

The human body communication section 53 is connected to the memory 51 and the electrode section 52, includes a transmitting section formed from an electric circuit that has a band-pass filter, and generates a transmission signal by modulating data to be transmitted. The human body communication section 53 may have a function to receive data. When the user holds the makeup tool 50 and touches the human body communication section 53, the human body communication section 53 establishes human body communication with the human body communication section 29 of the portable device 20. When the human body communication is established, the human body communication section 53 transmits data stored in the memory 51 to the portable device 20 via the body of the user.

### Process Flow of the Display System 1 According to the Present Embodiment

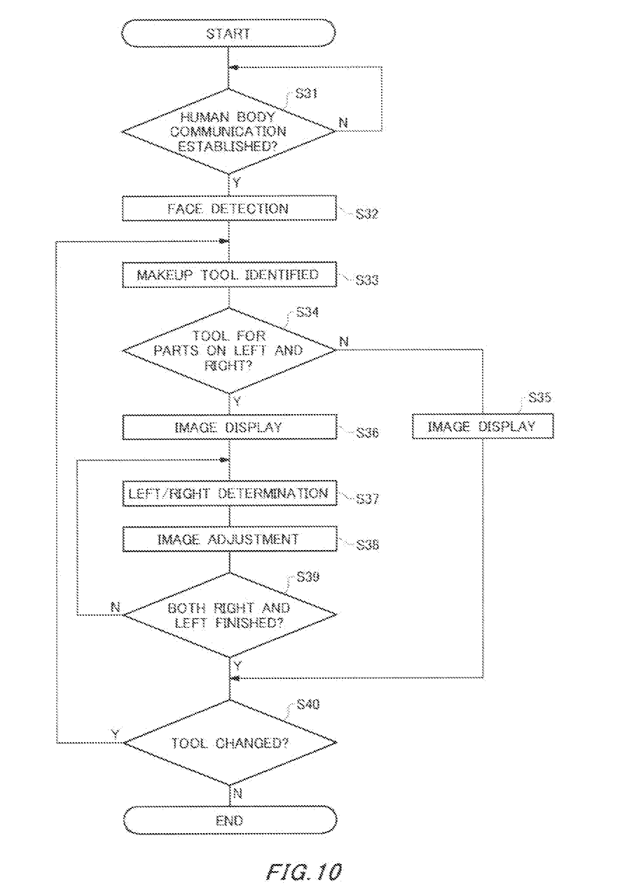

FIG. 10 shows the process flow of the control section 19 of the display apparatus 10 according to the present modification. This flow chart begins when the user grasps a makeup tool 50 such as an eye shadow applicator, human body communication is established between the makeup tool 50 and the portable device 20, and the control section 32 of the portable device 20 transmits an indication of the human body communication establishment to the display apparatus 10.

First, at step S31, the control section 19 confirms that a notification has been received indicating that human body communication has been established between the portable device 20 and the makeup tool 50. The control section 19 proceeds to the process of step S32 when the human body communication is established. Since the vibrating section 31 of the portable device 20 vibrates when human body communication or wireless communication is established, the user can recognize that communication is established even when the portable device 20 is placed in a pocket.

Nest, at step S32, the control section 19 analyzes the image of the user captured by the image capturing section 11, and detects the face of the user within the image. For example, using an image analysis process, the control section 19 detects the outline of the face of the user, and also the positions and shapes of facial features such as the eyes, nose, and mouth.

Next, at step S33, the control section 19 receives via wireless communication from the portable device 20 the information in the memory 51 of the makeup tool 50, which is the information identifying the makeup tool 50, that was transmitted from the makeup tool 50 to the portable device 20 in response to the establishment of the human body communication, and identities the type of makeup tool 50 being held in the hand of the user. For example, the control section 19 determines whether the makeup tool 50 held in the hand of the user is eyeliner or lipstick. The control section 19 may perform steps S32 and S33 in the opposite order.

Next, at step S34, the control section 19 determines whether the identified makeup tool 50 is a tool that is used on a body part present on both the right and left sides. For example, when the identified makeup tool 50 is to be used on the eyes, eyebrows, eyelashes, cheeks, or ears, the control section 19 determines that the tool is to be used on right and left side positions. Furthermore, when the identified makeup tool 50 is to be used on the mouth or nose, the control section 19 determines that the tool is to be used on a position not present on both the right and left sides.

As an example, the control section 19 determines whether the tool is to be used at left and right side positions based on the information in the memory 51 (information indicating whether a body part is on both the right and left sides of the body) transmitted from the makeup tool 50 to the portable device 20 in response to the establishment of the human body communication. Furthermore, the control section 19 predicts whether the tool is to be used on a body part on both the left and right side based on the type of makeup tool 50 identified.

In a case where the identified makeup tool 50 is to be used on a body part that is not on both the left and right sides, the control section 19 proceeds to the process of step S35.

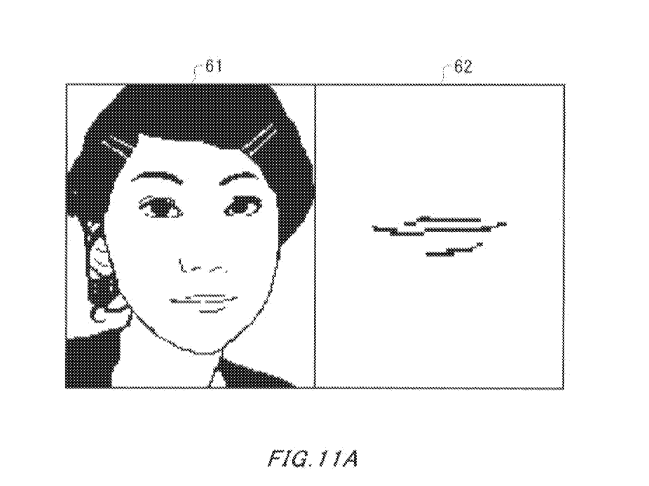

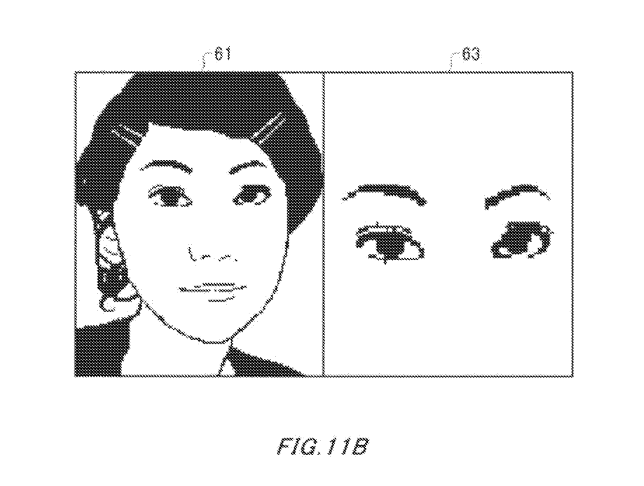

At step S35, the control section 19 displays next to each other, in the display section 13, an image of the face of the user and an image in which the part of the body on which the identified makeup tool 50 is to be used is enlarged. For example, as shown in FIG. 11A, when the makeup tool 50 is identified as lipstick, the control section 19 displays a divided image 61 showing the entire face and an enlarged image 62 of the mouth as separate right and left images in the display section 13.

The control section 19 may determine which body part to display in an enlarged manner based on information in the memory 51 (information indicating the body part on which the makeup tool 50 is to be used) that is transmitted from the makeup tool 50 to the portable device 20 in response to the establishment of the human body communication, or may predict which body part to display in an enlarged manner based on the type of the identified makeup tool 50. When the display process of step S35 ends, the control section 19 proceeds to the process of step S40.

When the identified makeup tool 50 is to be used for a body part present on both the right and left sides, the control section 19 proceeds to the process of step S36.

At step S36, the control section 19 displays the image of the face of the user and the image in which the body parts on which the identified makeup tool 50 is to be used (a region including both the left and right body parts) is enlarged next to each other in the display section 13. For example, as shown in FIG. 11B, when the makeup tool 50 is identified as eyeliner, the control section 19 displays a divided image 61 showing the entire face and an enlarged image 63 of a region containing both eyes as separate right and left images in the display section 13. The control section 19 may display one of the image of the entire face and the enlarged image of both eyes in the center of the display section 13.

Next, at step S37, the control section 19 determines whether the user applies the makeup to the right side body part or to the left side body part, based on the image of the user captured by the image capturing section 11. For example, when the makeup tool 50 is eyeliner, the control section 19 determines whether the user will apply the makeup to the right eye or the left eye.

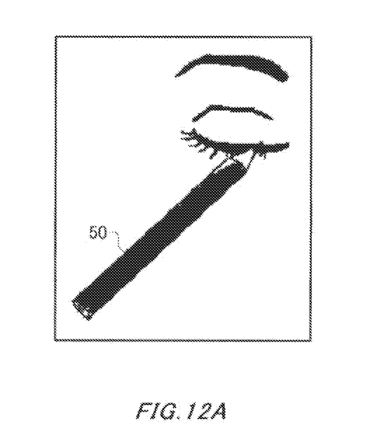

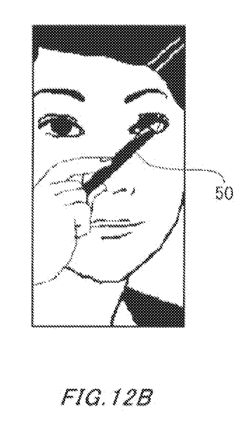

FIG. 12A shows a state in which the user holds the makeup tool 50 in the right hand and applies the makeup to the right eye. FIG. 12B shows a state in which the user holds the makeup tool 50 in the right hand and applies the makeup to the left eye. When the user holds the eyeliner or eye shadow applicator and applies the makeup to the right eye, the user generally closes the right eye. Accordingly, the control section 19 determines whether the right eye or the left eye is closed, based on the captured image, and may determine that makeup is being applied to the right eye if the right eye is closed and that makeup is being applied to the left eye if the left eye is closed.

When eyeliner is held in the right hand and applied to the right eye, the nose is not hidden, but when the eyeliner is held in the right hand and applied to the left eye, a portion of the nose is hidden. Furthermore, the control section 19 can determine whether the eyeliner is held with the right or left hand by detecting the angle of the eyeliner. Accordingly, the control section 19 may detect whether the eyeliner is held in the right hand according to the angle of the eyeliner and further detect whether the nose of the user is hidden, based on the captured image, and may determine whether the user is applying the makeup to the right eye or to the left eye.

The makeup tool 50 may include an acceleration sensor or a gyro, for example. In this case, the control section 19 may acquire the detection results of the acceleration sensor or gyro, predict the movement direction or orientation of the makeup tool 50, and determine whether the makeup is being applied to a body part on the right side or a body part on the left side.

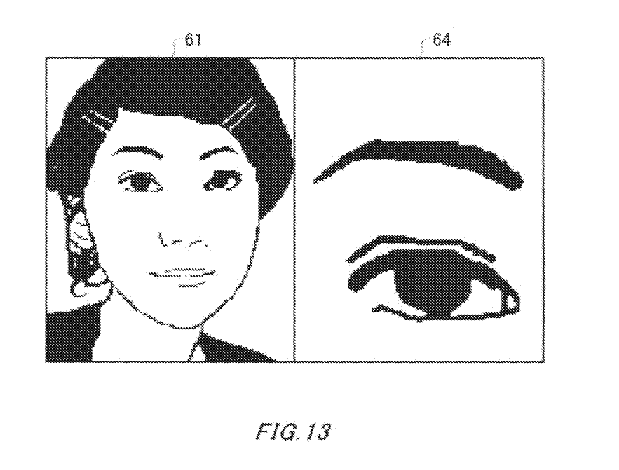

Next, at step S38, the control section 19 enlarges and displays the body part on the side determined at step S37, from among the right side and left side body parts. For example, as shown in FIG. 13, when it is determined that makeup is being applied to the left eye, the control section 19 displays the enlarged image 64 of the left eye. Furthermore, after the makeup has been applied to the left eye, when it is determined that makeup is being applied to the right eye, the control section 19 switches the display from the enlarged image 64 of the left eye to the enlarged image of the right eye.

Next, at step S39, the control section 19 determines whether the application of makeup has been finished for both the right and left body parts. For example, when the user has finished applying makeup to both the right and left body parts and removed their hand from the makeup tool 50 such that the human body communication between the makeup tool 50 and the portable device 20 ends, the control section 19 determines that the application of makeup has been finished for both the right and left body parts. If the makeup has only been applied to one side, the control section 19 returns to the process of step S37 and repeats the process until the process is finished for both the right and left body parts.

After the application of makeup to the right body part has finished and the application of makeup to the left body part is currently taking place, for example, there may be concern about maintaining balance between the left and right side makeup. In such a case, the control section 19 may switch between the left and right displayed enlarged images in response to user instructions, for example. Furthermore, in response to user instructions, the control section 19 may switch to display including the entirety of the body parts on both sides instead of the image of the entire face or may simultaneously display the enlarged image of the right body part and the enlarged image of the left body part.

The control section 19 may store image data showing a popular makeup example in advance in the memory section 15, and may display this example as virtual lines or virtual colors overlapping the image of the face of the user. Furthermore, the control section 19 may store makeup data indicating representative hairstyles and examples of makeup that suit those hairstyle in the memory section 15 in advance, determine the hairstyle of the user based on the image captured by the image capturing section 11, and provide advice by displaying a makeup example corresponding to the hairstyle stored in the memory section 15. In this case, the control section 19 may store a plurality of pieces of makeup data at the memory section 15 in association with age, season, clothing, and the like.

When the application of makeup is finished for both the left and right body parts, the control section 19 proceeds to the process of step S40.

At step S40, the control section 19 determines whether the makeup tool 50 has been changed. If the makeup tool 50 has been changed to another makeup tool 50, e.g. if the eyeliner has been changed to an eyebrow pencil for drawing on eyebrows, the control section 19 returns to the process of step S33 and repeats this process. Furthermore, in a case where the makeup tool 50 has not been changed and there has been no human body communication between the makeup tool 50 and the portable device 20 for a predetermined time, e.g. from tens of seconds to about one minute, the control section 19 determines that makeup application is finished and ends this flow chart.

In the present modification, communication is performed between the makeup tool 50 and the display apparatus 10 while passing through the portable device 20, but the display system 1 may perform communication by establishing human body communication or close proximity wireless communication between live makeup tool 50 and the display apparatus 10. Furthermore, the portable device 20 may be provided with a mirror function, e.g. attaching a half-mirror film to the display section 21, to perform communication by establishing human body communication or close proximity communication between the makeup tool 50 and the portable device 20. In this case, the image capturing section 25 of the portable device 20 may be driven by a drive mechanism to adjust the position for capturing an image of the user.

The display system 1 may store an image of the user after the application of makeup in the flash memory 27 of the portable device 20, for example, to save a makeup history. The display system 1 may display the past makeup history of the user as advice. The display system 1 may notify the user about a personal color, which is a color that suits the user, from the saved makeup history.

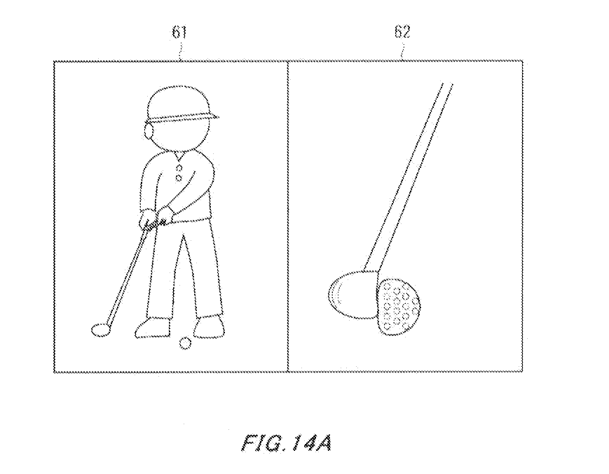

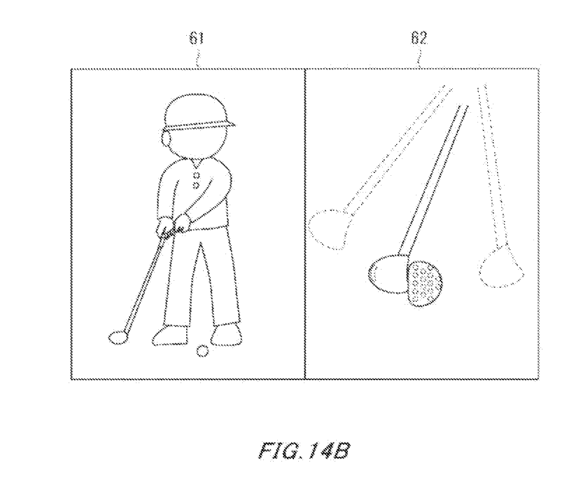

The above uses the makeup tools 50 as an example to describe the display control according to the instruments in the hands of the user, but instead of makeup tools 50, tools used for sports such as golf clubs or tennis rackets may be used. For example, the display apparatus 10 can be applied to check the form or swing of the user. Specifically, the control section 19 displays a divided image 61 of showing the entire body of the user and an enlarged image 62 showing the tool in the hand over time, in the display section 13. FIG. 14A shows a state in which one enlarged image is displayed. FIG. 14B shows a state in which a plurality of enlarged images over time are shown. In this case, the control section 19 may display one enlarged image as shown in FIG. 14A or may display a plurality of enlarged images 62 over time as shown in FIG. 14B (though enlargement is not necessary), thereby enabling the user to see the position and openness of the golf head, for example, in the display apparatus 10.

While the embodiments of the present invention have been described, the technical scope of the invention is not limited to the above described embodiments. It is apparent to persons skilled in the art that various alternatives and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. An electronic device comprising:
an input section that inputs information relating to a first instrument in a hand of a user; and
a control section that controls display in a display section based on the information input by the input section.

2. The electronic device according to claim 1, comprising:
an image capturing section that is capable of capturing an image of the user and the first instrument.

3. The electronic device according to claim 2, comprising:
an image adjusting section that adjusts the image captured by the image capturing section, according to the first instrument in the hand of the user.

4. The electronic device according to claim 3, wherein
the image adjusting section adjusts at least one of a display region and size of the image captured by the image capturing section.

5. The electronic device according to claim 2, comprising:
a determining section that determines what body part of the riser the first instrument is to be used on, based on the information relating to the first instrument.

6. The electronic device according to claim 5, wherein
the determining section determines whether the first instrument is to be used on a body part on a right side of the user or a body part on a left side of the user.

7. The electronic device according to claim 1, wherein
the control section controls a divided display on a display screen, based on the information input by the input section.

8. The electronic device according to claim 7, wherein
the control section displays a face of the user in a first region of the display screen and displays a portion of the face of the user in a second region of the display screen.

9. The electronic device according to claim 8, wherein
the control section displays the portion of the face of the user in the second region in an enlarged manner.

10. The electronic device according to claim 1, wherein
the control section provides a display relating to the first instrument overlapping the display on the display section.

11. The electronic device according to claim 1, comprising:
a first communication section that communicates with the first instrument through close proximity communication or through a human body.

12. A computer readable medium storing thereon a program that causes a computer to function as the electronic device according to claim 1.

13. A method comprising:
inputting information relating to a first instrument in a hand of a user; and
controlling display in a display section based on the input information.

14. An electronic device comprising:
an input section that inputs information relating to a first instrument in a hand of a user; and
a predicting section that predicts movement of the user based on the information input by the input section.

15. The electronic device according to claim 14, wherein
the first instrument is a tool to be used on a specific body part, and
the predicting section identifies the first instrument based on the information input by the input section, and determines a body part that is to be a target on which the user uses the first instrument.

16. The electronic device according to claim 14, comprising:
a first communication section that communicates with the first instrument through close proximity communication or through a human body.

17. The electronic device according to claim 16, comprising:
a second communication section that communicates with an external device using a communication method other than the communication through a human body.

18. The electronic device according to claim 14, comprising:
a third communication section that communicates with a portable device, wherein
the input section inputs information relating to the first instrument from the portable device through the third communication section.

19. The electronic device according to claim 14, comprising:
an information providing section that provides information relating to the first instrument.

20. The electronic device according to claim 14, comprising:
a storage section that stores a usage history of the first instrument.

21. The electronic device according to claim 14, comprising:
an image capturing section that is capable of capturing an image of the user and the first instrument.

22. The electronic device according to claim 21, wherein
the predicting section predicts the movement of the user based on image capturing results of the image capturing section.

23. The electronic device according to claim 22, wherein
the predicting section predicts the movement of the user based on the information relating to the first instrument and the image capturing results of the image capturing section.

24. The electronic device according to claim 21, wherein
the predicting section predicts whether a body part is on a right side or a left side, based on the image capturing results of the image capturing section.

25. The electronic device according to claim 21, wherein
the image capturing section is capable of capturing an image of a face of the user, and
the predicting section predicts the movement of the user based on the face of the user captured by the image capturing section.
